(19) United States
(12) Patent Application Publication
(10) Pub. No.: US 2014/0062357 A1
(43) Pub. Date: Mar. 6, 2014

(54) MOTOR DRIVING APPARATUS AND OPERATING METHOD THEREOF

(71) Applicant: SAMSUNG ELECTRO-MECHANICS CO., LTD., Gyunggi-do (KR)

(72) Inventor: Joo Yul KO, Gyunggi-do (KR)

(73) Assignee: SAMSUNG ELECTRO-MECHANICS CO., LTD., Gyunggi-do (KR)

(21) Appl. No.: 13/668,888

(22) Filed: Nov. 5, 2012

(30) Foreign Application Priority Data
Sep. 5, 2012 (KR) 10-2012-0098444

(51) Int. Cl. H02P 6/16

(52) U.S. Cl. 318/400.05

(57) ABSTRACT

There are a motor driving apparatus and an operating method thereof, the motor driving apparatus including: a speed sensor generating a sensor output signal of a motor; a reference signal generating unit generating a reference signal by using the sensor output signal; a pulse counting unit counting the reference signal during a pulse width period of the sensor output signal to provide a count value; and a glitch controlling unit determining whether a glitch is present or not using the count value to remove a glitch when present.

### CROSS-REFERENCE TO RELATED APPLICATIONS

This application claims the priority of Korean Patent Application No. 10-2012-0098444 filed on Sep. 5, 2012, in the Korean Intellectual Property Office, the disclosure of which is incorporated herein by reference.

### BACKGROUND OF THE INVENTION

1. Field of the Invention

The present invention relates to a motor driving apparatus capable of removing a glitch included in an output signal of a speed sensor of a motor, and an operating method thereof.

2. Description of the Related Art

Generally, during driving a motor, the motor is controlled to have a desired speed through the speed thereof being monitored. For motor speed control as described above, the speed of the motor is detected using a sensor such as a hall sensor, an optical sensor, or the like.

However, a glitch may be undesirably included in an output signal of the sensor due to various causes such as noise introduced from the outside, sensor problems, or the like.

As described above, in the existing motor driving apparatus, in the case in which the glitch is included in signals output from the motor sensor, a position of a rotor of the motor may be incorrectly recognized as the position thereof having changed, and thus, a phase of a driving signal may be changed. Therefore, the actual position of the motor and the recognized position of the motor do not coincide with each other, such that driving may not be accurately performed.

In addition, due to inaccurate position recognition as described above, back torque maybe generated, such that current consumption may be increased and motor rotation speed may be decreased.

In the following Related Art Document, which relates to a method of removing a glitch and an removing apparatus thereof, a technology for detecting and removing the glitch using a reference signal generated based on a current speed of the motor is not disclosed.

### RELATED ART DOCUMENT

Korean Patent Laid-Open Publication No. 10-2004-0016147

### SUMMARY OF THE INVENTION

An aspect of the present invention provides a motor driving apparatus capable of detecting and removing a glitch included in a sensor output signal of a speed sensor of a motor by using a reference signal generated according to a speed of the motor, and an operating method thereof.

According to an aspect of the present invention, there is provided a motor driving apparatus including: a speed sensor generating a sensor output signal of a motor; a reference signal generating unit generating a reference signal by using the sensor output signal; a pulse counting unit counting the reference signal during a pulse width period of the sensor output signal to provide a count value; and a glitch controlling unit determining whether a glitch is present or not using the count value to remove a glitch when present.

The reference signal generating unit may multiply the sensor output signal to generate the reference signal.

The reference signal generating unit may include: a signal detector averaging the sensor output signal; and a frequency multiplier multiplying the sensor output signal averaged in the signal detector by a preset multiplication value.

The glitch controlling unit may recognize a pulse included in the sensor output signal as a glitch when the count value is smaller than a preset reference count value and recognize the pulse included in the sensor output signal as a normal pulse when the count value is equal to or larger than the reference count value.

The glitch controlling unit may reduce a level of the pulse recognized as the glitch to a relatively low level when the glitch controlling unit recognizes the pulse included in the sensor output signal as the glitch.

The glitch controlling unit may stop an operation of removing the glitch during a first pulse cycle of the sensor output signal when a change in speed of the motor exceeds a preset change in speed reference value, based on a pulse width modulation (PWM) signal for changing a speed.

According to another aspect of the present invention, there is provided an operating method of a motor driving apparatus, the operating method including: generating a reference signal by using a sensor output signal from a speed sensor of a motor; counting the reference signal during a pulse width period of the sensor output signal to provide a count value; determining whether a glitch is present or not using the count value; and removing the corresponding glitch when the glitch is present in the sensor output signal.

In the generating of the reference signal, the reference signal may be generated by multiplying the sensor output signal.

The generating of the reference signal may include: averaging the sensor output signal; and multiplying the averaged sensor output signal by a preset multiplication value.

In the removing of the glitch, when the count value is smaller than a preset reference count value, a pulse included in the sensor output signal may be recognized as a glitch, and when the count value is equal to or larger than the reference count value, the pulse included in the sensor output signal may be recognized as a normal pulse.

In the removing of the glitch, when the pulse included in the sensor output signal is recognized as the glitch, a level of the pulse recognized as the glitch may be reduced to a relatively low level.

In the removing of the glitch, an operation of removing the glitch may be stopped during a first pulse cycle of the sensor output signal when a change in speed of the motor exceeds a preset change in speed reference value, based on a PWM signal for changing a speed.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a motor driving apparatus according to an embodiment of the present invention;

FIG. 2 is a modified block diagram of the motor driving apparatus according to the embodiment of the present invention;

FIG. 3 is a flow chart illustrating an operating method of the motor driving apparatus according to the embodiment of the present invention;

FIG. 4 is a flow chart illustrating an operation of generating a reference signal according to the embodiment of the present invention;

FIG. 5 is a flow chart illustrating an operation of generating a detection signal according to the embodiment of the present invention;

FIG. 6 is a diagram illustrating an example of a sensor output signal according to the embodiment of the present invention; and

FIGS. 7 and 8 are diagrams illustrating examples of reference signals and glitches at a low speed and a high speed according to the embodiment of the present invention, respectively.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements.

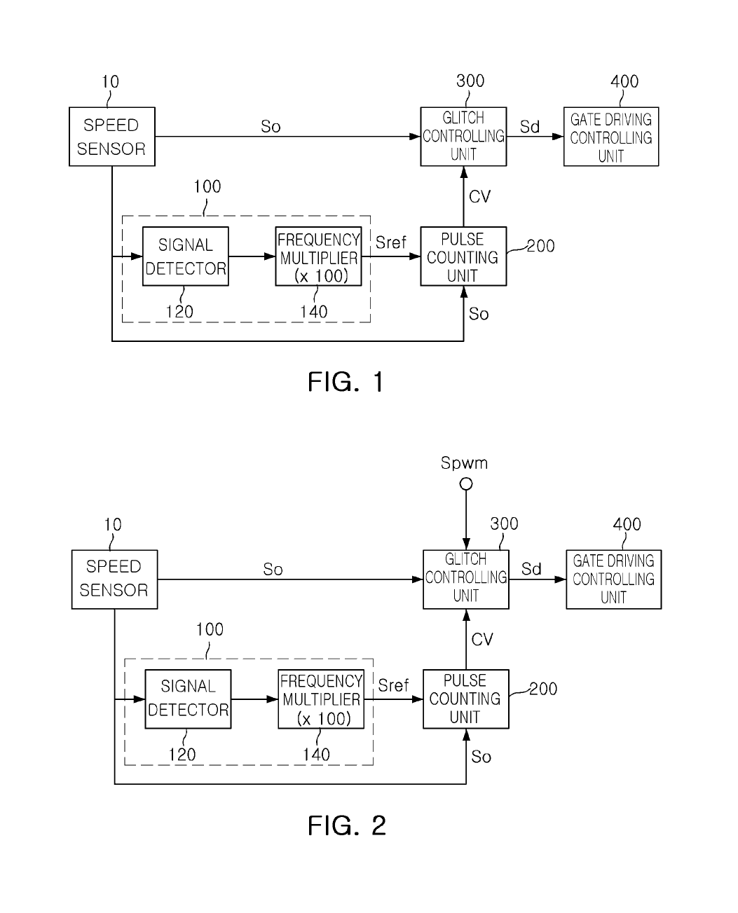

FIG. 1 is a block diagram of a motor driving apparatus according to an embodiment of the present invention and FIG. 2 is a modified block diagram of a motor driving apparatus according to an embodiment of the present invention.

Referring to FIGS. 1 and 2, the motor driving apparatus according to the embodiment of the present invention may include a speed sensor 10 generating sensor output signals So of the motor, a reference signal generating unit 100 generating reference signals Sref by using the sensor output signal So, a pulse counting unit 200 counting the reference signal Sref to provide a count value CV during a pulse width period of the sensor output signal So, and a glitch controlling unit 300 determining whether a glitch is present or not using the count value CV to remove a glitch when present.

Here, the glitch controlling unit 300 may provide a detection signal Sd obtained by removing the glitch from the sensor output signal So to a gate driving controlling unit 400.

The speed sensor 10 may detect a current rotation speed of the motor to generate the sensor output signal So. In this case, the sensor output signal So may have a pulse frequency corresponding to the rotation speed of the motor. Here, the speed sensor may be, for example, a hall sensor, an optical sensor, or the like, but is not limited thereto.

The reference signal generating unit 100 may generate the reference signal Sref by using the sensor output signal So from the speed sensor 10. For example, the reference signal generating unit 100 may multiply the sensor output signal So to generate the reference signal.

The pulse counting unit 200 may count the reference signal Sref during the pulse width period of the sensor output signal So to provide the count value CV. For example, when the reference signal Sref is a signal obtained by multiplying a frequency of the sensor output signal So by 100 times, fifty pulses maybe counted during one cycle of the pulse width period, and the count value CV may be 50 in this case. Unlike this, when a signal being less than 10% of a normal pulse width is referred as a glitch, since the number of pulses less than 5 may be counted in the case of glitch, the count value may be smaller than 5 in this case.

In addition, the glitch controlling unit 300 may determine whether the glitch is present or not using the count value CV, to thus remove a glitch present in the sensor output signal So.

The reference signal generating unit 100 may include a signal detector 120 averaging the sensor output signals So and a frequency multiplier 140 multiplying the sensor output signal averaged in the signal detector 120 by a preset multiplication value.

In the reference signal generating unit 100, the signal detector 120 may average the sensor output signals So to provide the averaged sensor output signal to the frequency multiplier 140.

Further, the frequency multiplier 140 may multiply the sensor output signal averaged in the signal detector 120 by the preset multiplication value to provide the reference signal Sref to the pulse counting unit 200. Here, the multiplication value, which maybe set in consideration of accuracy of counting and implementation in a system, may be set, for example, to ‘100’.

In addition, the glitch controlling unit 300 may recognize a pulse included in the sensor output signal So as a glitch when the count value CV is smaller than a preset reference count value and recognize a pulse included in the sensor output signal So as a normal pulse when the count value CV is equal to or larger than the reference count value.

In the glitch controlling unit 300, for example, in the case in which the reference count value is set to ‘5’, when the count value CV is ‘3’, since the count value is smaller than 5, which is the preset reference count value, the pulse included in the sensor output signal So may be recognized as the glitch, and when the count value CV is ‘7’, since the count value is larger than 5, which is the reference count value, the pulse included in the sensor output signal So may be recognized as the normal pulse.

When the glitch controlling unit 300 recognizes the pulse included in the sensor output signal as the glitch, a level of the pulse recognized as the glitch may be reduced to a relatively low level.

When the glitch controlling unit 300 recognizes the pulse included in the sensor output signal as the glitch, the level of the pulse recognized as the glitch is reduced to the low level, such that the glitch included in the sensor output signal So may be removed.

Referring to FIG. 2, the glitch controlling unit 300 may stop an operation of removing the glitch during a first pulse cycle of the sensor output signal when a change in speed of the motor exceeds a preset change in speed reference value, based on a pulse width modulation (PWM) signal Spwm for changing a speed.

When the change in speed of the motor exceeds the preset change in speed reference value, since an error in glitch recognition may be generated, the glitch controlling unit 300 may stop the operation of removing the glitch during a first pulse cycle of the sensor output signal So, based on the PWM signal Spwm for changing a speed.

Through the above-mentioned operation, the error in which the glitch controlling unit 300 wrongly recognizes the glitch may be prevented.

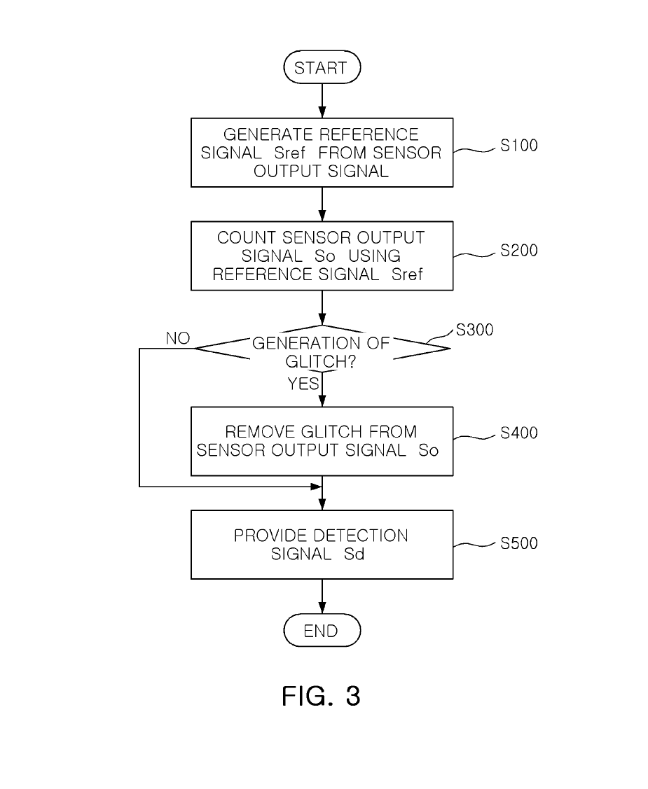

FIG. 3 is a flowchart illustrating an operating method of the motor driving apparatus according to the embodiment of the present invention.

Referring to FIG. 3, the operating method of the motor driving apparatus according to the embodiment of the present invention may include generating a reference signal Sref by using a sensor output signal So from a speed sensor 10 of the motor (S100), counting the reference signal Sref during a pulse width period of the sensor output signal So to provide a count value CV (S200), determining whether a glitch is present or not using the count value CV (S300), and removing the corresponding glitch when the glitch is present in the sensor output signal (S400).

In the operating method of the motor driving apparatus shown in FIG. 3, first, the reference signal Sref may be generated using the sensor output signal So from the speed sensor 10 of the motor by the reference signal generating unit 100 of FIG. 2 (S100 of FIG. 3).

Next, the reference signal Sref may be counted during the pulse width period of the sensor output signal So by the pulse counting unit 200 of FIG. 2, and the count value CV may be provided (S200 of FIG. 3).

Then, whether the glitch is present or not may be determined using the count value CV by the glitch controlling unit 300 (S300 of FIG. 3).

In addition, when the glitch is present in the sensor output signal, the corresponding glitch may be removed by the glitch controlling unit 300 (S400 of FIG. 3).

Further, the detection signal Sd obtained by removing the glitch from the sensor output signal So may be provided to the gate driving controlling unit 400 by the glitch controlling unit 300 (S500 of FIG. 3).

In the generating of the reference signal (S100), the reference signal may be generated by multiplying the sensor output signal So.

The reference signal may be generated by multiplying the sensor output signal So by a preset multiplication value. For example, in the case in which the multiplication value is set to ‘100’, the reference signal Sref may have a 100 times frequency of the sensor output signal So.

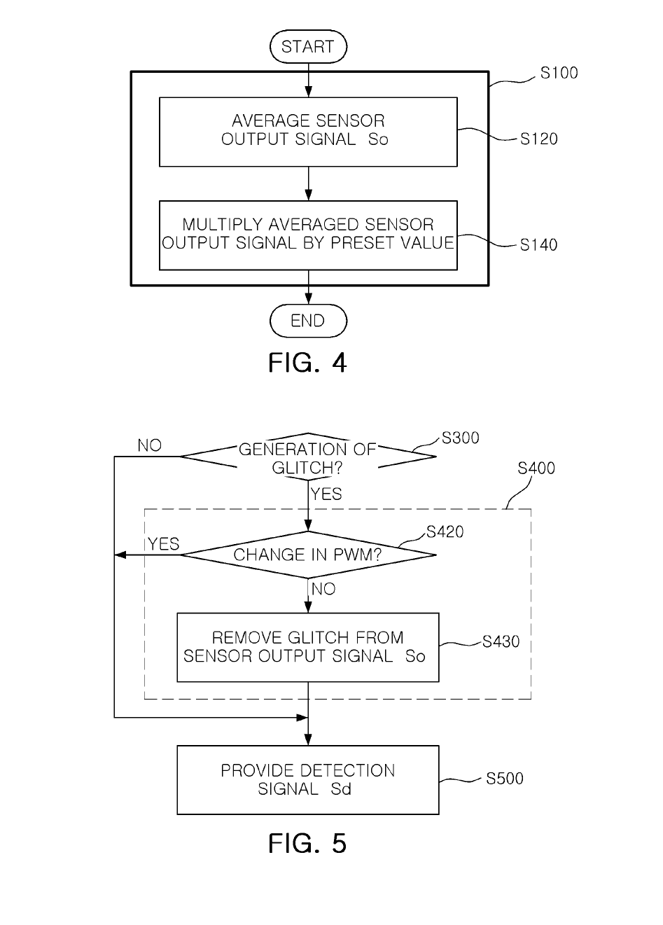

FIG. 4 is a flow chart illustrating an operation of generating a reference signal according to the embodiment of the present invention.

Referring to FIG. 4, the generating of the reference signal (S100) may include averaging the sensor output signals So (S120) and multiplying the averaged sensor output signal by a preset multiplication value (S140).

In the generating of the reference signal (S100), first, the sensor output signals So from the speed sensor 10 may be averaged (S120 of FIG. 4). In addition, the averaged sensor output signal may be multiplied by the preset multiplication value (S140 of FIG. 4).

Further, referring to FIG. 3, in the removing of the glitch (S400), when the count value CV is smaller than a preset reference count value, a pulse included in the sensor output signal So maybe recognized as a glitch, and when the count value CV is equal to or larger than the reference count value, a pulse included in the sensor output signal So may be recognized as a normal pulse. In the removing of the glitch (S400), when the pulse included in the sensor output signal is recognized as the glitch, a level of the pulse recognized as the glitch may be reduced to a relatively low level.

In the removing of the glitch (S400), when the count value CV is smaller than the preset reference count value, the pulse included in the sensor output signal may be recognized as the glitch. Further, when the count value CV is equal to or larger than the reference count value, the pulse included in the sensor output signal may be recognized as the normal pulse.

In addition, when the pulse included in the sensor output signal is recognized as the glitch, the glitch may be removed by changing the level of the pulse recognized as the glitch into the low level.

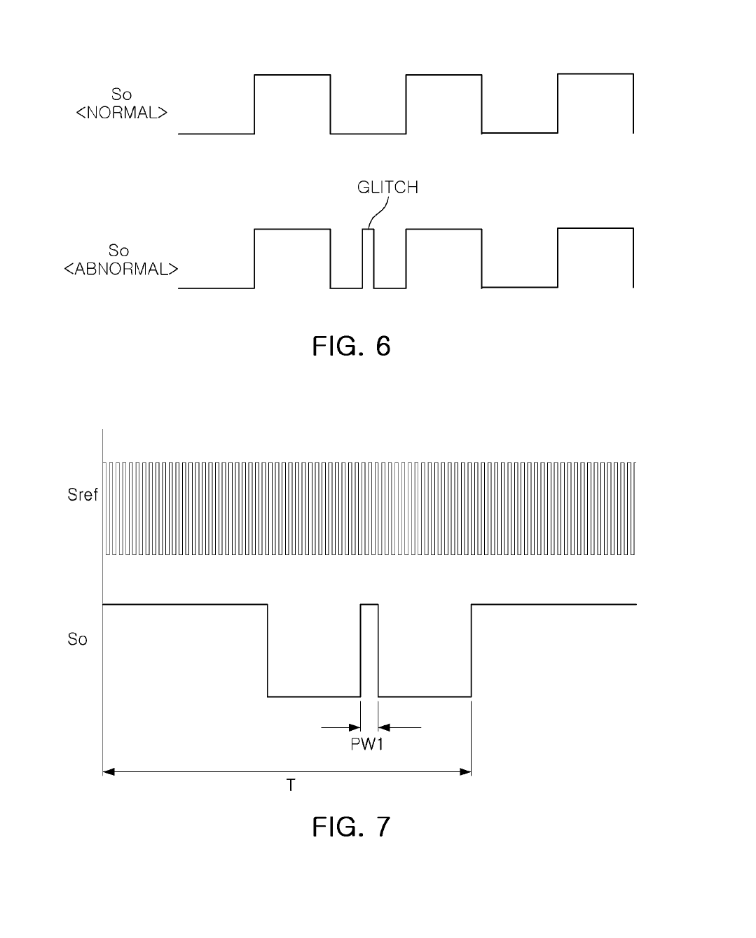

FIG. 5 is a flow chart illustrating an operation of generating a detection signal according to another embodiment of the present invention.

Referring to FIG. 5, in the removing of the glitch (S400), an operation of removing the glitch maybe stopped during a first pulse cycle of the sensor output signal when a change in speed of the motor exceeds a preset change in speed reference value, based on a PWM signal Spwm for changing a speed.

In the removing of the glitch (S400), the operation of removing the glitch may be stopped during the first pulse cycle of the sensor output signal when the change in speed of the motor exceeds the preset change in speed reference value, based on a PWM signal Spwm for changing a speed.

FIG. 6 is a diagram of a sensor output signal according to the embodiment of the present invention.

Referring to FIG. 6, it may be appreciated that a normal sensor output signal So does not include a glitch, while an abnormal sensor output signal So includes the glitch.

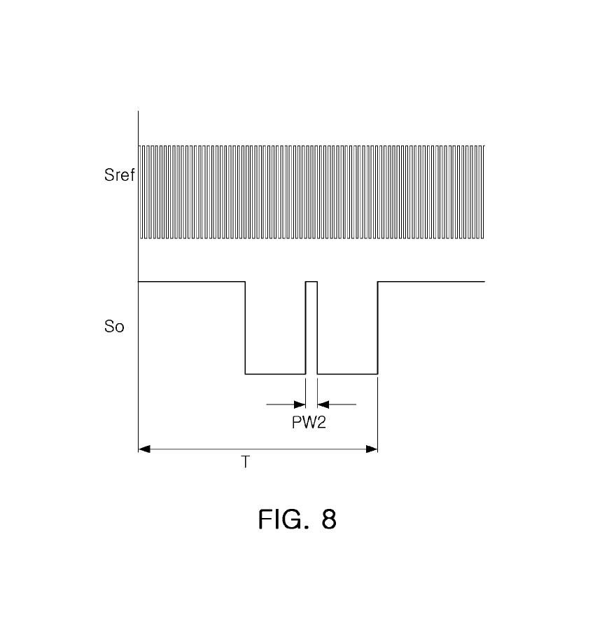

FIG. 7 is a diagram illustrating examples of a reference signal and a glitch at a low speed according to the embodiment of the present invention, FIG. 8 is a diagram illustrating examples of a reference signal and a glitch at a high speed according to the embodiment of the present invention.

Referring to FIGS. 7 and 8, in the embodiment of the present invention, the reference signal is a signal generated by multiplying the sensor output signal. That is, although a pulse width PW1 of FIG. 7 and a pulse width PW2 of FIG. 8 are different from each other, since the frequency of the reference signal is synchronized to thereby be changed corresponding thereto, the glitch may be more accurately detected regardless of rotation speed of the motor.

As set forth above, according to the embodiments of the present invention, the glitch included in the output signal of the speed sensor of the motor may be detected and removed using the reference signal generated according to the speed of the motor.

In addition, removal of the glitch is stopped during the first cycle when the motor speed is not changed, based on the PWM signal, such that determination with respect to the glitch and removal of the glitch may be more accurately performed.

While the present invention has been shown and described in connection with the embodiments thereof, it will be apparent to those skilled in the art that modifications and variations can be made without departing from the spirit and scope of the invention as defined by the appended claims.

What is claimed is:

1. A motor driving apparatus comprising:
a speed sensor generating a sensor output signal of a motor;
a reference signal generating unit generating a reference signal by using the sensor output signal;
a pulse counting unit counting the reference signal during a pulse width period of the sensor output signal to provide a count value; and
a glitch controlling unit determining whether a glitch is present or not using the count value to remove a glitch when present.

2. The motor driving apparatus of claim 1, wherein the reference signal generating unit multiplies the sensor output signal to generate the reference signal.

3. The motor driving apparatus of claim 1, wherein the reference signal generating unit includes:
a signal detector averaging the sensor output signal; and
a frequency multiplier multiplying the sensor output signal averaged in the signal detector by a preset multiplication value.

4. The motor driving apparatus of claim 1, wherein the glitch controlling unit recognizes a pulse included in the sensor output signal as a glitch when the count value is smaller than a preset reference count value and recognizes the pulse included in the sensor output signal as a normal pulse when the count value is equal to or larger than the reference count value.

5. The motor driving apparatus of claim 4, wherein the glitch controlling unit reduces a level of the pulse recognized as the glitch to a relatively low level when the glitch controlling unit recognizes the pulse included in the sensor output signal as the glitch.

6. The motor driving apparatus of claim 1, wherein the glitch controlling unit stops an operation of removing the glitch during a first pulse cycle of the sensor output signal, when a change in speed of the motor exceeds a preset change in speed reference value, based on a pulse width modulation (PWM) signal for changing a speed.

7. An operating method of a motor driving apparatus, the operating method comprising:
generating a reference signal by using a sensor output signal from a speed sensor of a motor;
counting the reference signal during a pulse width period of the sensor output signal to provide a count value;
determining whether a glitch is present or not using the count value; and
removing the corresponding glitch when the glitch is present in the sensor output signal.

8. The operating method of claim 7, wherein in the generating of the reference signal, the reference signal is generated by multiplying the sensor output signal.

9. The operating method of claim 7, wherein the generating of the reference signal includes:
averaging the sensor output signal; and
multiplying the averaged sensor output signal by a preset multiplication value.

10. The operating method of claim 7, wherein in the removing of the glitch, when the count value is smaller than a preset reference count value, a pulse included in the sensor output signal is recognized as a glitch, and when the count value is equal to or larger than the reference count value, the pulse included in the sensor output signal is recognized as a normal pulse.

11. The operating method of claim 10, wherein in the removing of the glitch, when the pulse included in the sensor output signal is recognized as the glitch, a level of the pulse recognized as the glitch is reduced to a relatively low level.

12. The operating method of claim 7, wherein in the removing of the glitch, an operation of removing the glitch is stopped during a first pulse cycle of the sensor output signal when a change in speed of the motor exceeds a preset change in speed reference value, based on a PWM signal for changing a speed.
